(19) United States
(12) Patent Application Publication
(10) Pub. No.: US 2025/0306904 A1
(43) Pub. Date: Oct. 2, 2025

(54) UPDATE METHOD AND ELECTRONIC DEVICE

(71) Applicant: Lenovo (Beijing) Limited, Beijing (CN)

(72) Inventor: Qinghua Yu, Beijing (CN)

(21) Appl. No.: 19/091,350

(22) Filed: Mar. 26, 2025

(30) Foreign Application Priority Data
Mar. 29, 2024 (CN) 202410383244.6

(51) Int. Cl. G06F 8/65; G06F 40/205

(52) U.S. Cl. CPC G06F 8/65; G06F 40/205

(57) ABSTRACT

An update method and an electronic device are provided. The update method includes: obtaining target information, where the target information is configured to determine a target application and a target operation scenario; and, in response to determining that the target application does not meet a target condition, updating the target application such that the target application meets the target condition, where the target condition indicates that the target application is able to operate normally in the target operation scenario.

### CROSS-REFERENCE TO RELATED APPLICATION

This application claims priority to Chinese Patent Application No. 202410383244.6, filed on Mar. 29, 2024, the entire content of which is incorporated herein by reference.

### TECHNICAL FIELD

The present disclosure generally relates to the field of computer technologies and, more particularly, to an update method and an electronic device.

### BACKGROUND

During the use of an application on electronic devices, there may be situations where the application cannot run normally because of the version being too old. In this case, the application can only run normally after being updated. The above problems in the application may cause users to be unable to use the application normally.

### SUMMARY

In accordance with various embodiments of the present disclosure, there is provided an update method. The update method includes: obtaining target information, where the target information is configured to determine a target application and a target operation scenario; and, in response to determining that the target application does not meet a target condition, updating the target application such that the target application meets the target condition, where the target condition indicates that the target application is able to operate normally in the target operation scenario.

In accordance with various embodiments of the present disclosure, there is also provided an electronic device. The electronic device includes one or more processors; and a memory coupled with the one or more processors and containing at least one instruction that, when being executed, causes the one or more processors to: obtain target information, where the target information is configured to determine a target application and a target operation scenario; and, in response to determining that the target application does not meet a target condition, update the target application such that the target application meets the target condition, where the target condition indicates that the target application is able to operate normally in the target operation scenario.

In accordance with various embodiments of the present disclosure, there is also provided a non-transitory computer readable storage medium containing at least one instruction that, when being executed, causes at least one processor to obtain target information, where the target information is configured to determine a target application and a target operation scenario; and, in response to determining that the target application does not meet a target condition, update the target application such that the target application meets the target condition, where the target condition indicates that the target application is able to operate normally in the target operation scenario.

### BRIEF DESCRIPTION OF THE DRAWINGS

FIG. 1 is a schematic diagram of an application scenario of an update method consistent with various embodiments of the present disclosure.

FIG. 2 is a flowchart of an update method consistent with various embodiments of the present disclosure.

FIG. 3 is a flowchart for obtaining target information consistent with various embodiments of the present disclosure.

FIG. 4 is a schematic diagram of detecting a target application consistent with various embodiments of the present disclosure.

FIG. 5 is a schematic diagram of a display picture consistent with various embodiments of the present disclosure.

FIG. 6 is a schematic structural diagram of an updating device consistent with various embodiments of the present disclosure.

FIG. 7 is a schematic structural diagram of an electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

In the present disclosure, reference is made to “some embodiments” which describe a subset of all possible embodiments, but it is understood that “some embodiments” may be the same subset or a different subset of all possible embodiments, and can be combined with each other without conflict.

The terms “first/second/third” involved are only configured to distinguish similar objects and do not represent a specific ordering of objects. It is understood that “first/second/third” can be used interchangeably if permitted. The specific order or sequence may be changed such that the embodiments of the present disclosure described herein can be implemented in an order other than that illustrated or described herein.

Unless otherwise defined, all technical and scientific terms used herein have the same meaning as commonly understood by those of ordinary skill in the art in the technical field to which the present disclosure belongs. The terminology used herein is for the purpose of describing the present disclosure only and does not intend to limit the scope of the present disclosure. The nouns and terms involved in the embodiments of the present disclosure will be first described. The nouns and terms involved in the embodiments of the present disclosure are applicable to the following explanations.

In the present disclosure, the collection, storage, use, processing, transmission, provision, disclosure and application of the data involved (including but not limited to user personal information) comply with the provisions of relevant laws and regulations, take necessary confidentiality measures, and do not violate public order and good morals.

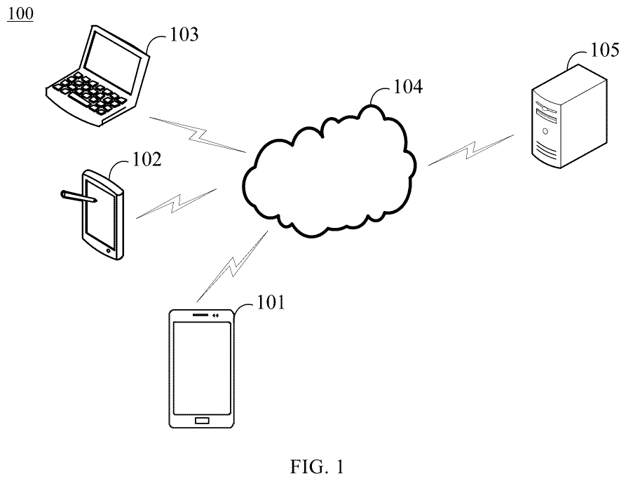

FIG. 1 is a schematic diagram of an application scenario of an update method according to an embodiment of the present disclosure.

In one embodiment, as shown in FIG. 1, the application scenario 100 may include terminal devices 101, 102, and 103, a network 104, and a server 105. The network 104 may be configured to provide a medium for a communication link between the terminal devices 101, 102, and 103 and the server 105. The network 104 may include various connection types, such as wired or wireless communication links or optical fiber cables, etc.

Users may use terminal devices 101, 102, and 103 to interact with the server 105 through the network 104 to receive or send messages, etc. Various communication client applications may be installed on the terminal devices 101, 102, and 103, such as shopping applications, web browser applications, search applications, instant messaging tools, email clients, social platform applications, etc. (only examples).

The terminal devices 101, 102, and 103 may be various electronic devices with display screens that support web browsing or application operation, including but not limited to smartphones, tablet computers, laptop portable computers, desktop computers, etc.

The server 105 may be a server that provides various services, such as a background management server that provides support for websites browsed by users using terminal devices 101, 102, and 103 (for example only). The background management server may analyze and process the received data such as user requests, and feedback the processing results (such as web pages, information, or data obtained or generated according to user requests) to the terminal devices 101, 102, and 103.

It should be noted that the update method provided by the present disclosure may generally be executed by the server 105. Accordingly, the update device provided by the present disclosure may generally be disposed in the server 105. In some other embodiments, the update method provided by the present disclosure may also be executed by a server or a server cluster that is different from the server 105 and may communicate with the terminal devices 101, 102, and 103 and/or the server 105. Accordingly, the update device may also be disposed in a server or server cluster that is different from the server 105 and may communicate with the terminal devices 101, 102, and 103 and/or the server 105.

It should be understood that the number of terminal devices, networks, and servers in FIG. 1 is only schematic. Depending on the implementation requirements, there may be any suitable number of terminal devices, networks, and servers.

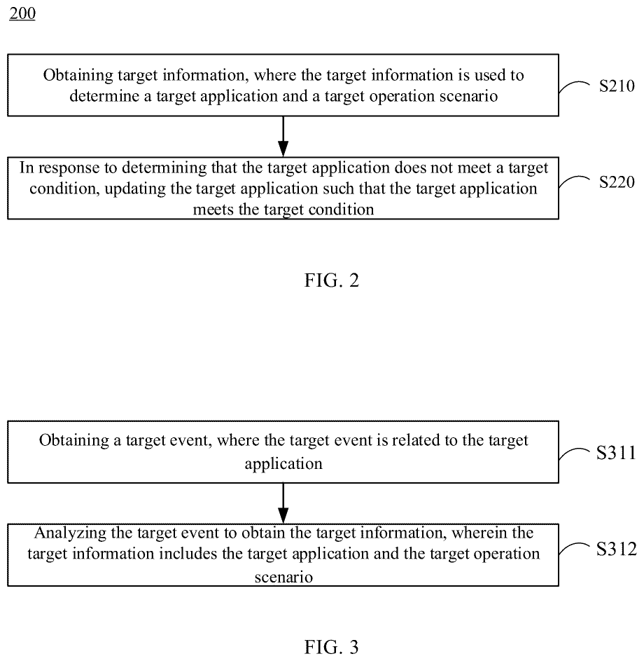

The present disclosure provides an update method. In one embodiment shown in FIG. 2 which is a flowchart of an update method consistent with embodiments of the present disclosure, the update method 200 may include S210 to S220.

In S210, target information is obtained, where the target information is configured to determine a target application and a target operation scenario.

In one embodiment of the present disclosure, the target application may include at least one application that needs to be run in the target operation scenario. For example, a mobile terminal may have multiple applications installed, and the target application may be at least one application that needs to be run in the target operation scenario among multiple applications. The target operation scenario may indicate a scenario in which the target application needs to be run. The target operation scenario may indicate the start time of the target application, the operation period, and the function that needs to be run.

For example, in one embodiment, the target application may be a conference application. The target operation scenario may be a video conference at 9:00 am on Monday. Based on the target operation scenario, it may be determined that the conference application needs to be run at 9:00 am on Monday, and the operation content may include operating a component for realizing multi-user conference communication and operating a component for realizing a video function.

For example, in another embodiment, the target application may be an email application. The target operation scenario may be sending a specified email to a specified user at 9:00 am on Monday. Based on the target operation scenario, it may be determined that the conference application needs to be run at 9:00 am on Monday, and the operation content may include operation a timing component and operating a component for sending emails.

In S220, in response to determining that the target application does not meet a target condition, the target application is updated such that the target application meets the target condition.

In one embodiment of the present disclosure, the target condition may represent that the target application is able to run normally under the target operation scenario. The operation of determining whether the target application meets the target condition may need to be completed before the start operation time indicated by the target operation scenario. When the target application does not meet the target condition, the update operation of the target application may also need to be completed before the start operation time indicated by the target operation scenario, ensuring that the updated target application is able to meet the target condition when the start operation time indicated by the target operation scenario is reached. The updated target application may be able to run normally under the target operation scenario and remain in a normal operation state until the target application ends.

In one embodiment of the present disclosure, the target application meeting the target condition may indicate that the target application is able to run normally under the target operation scenario. For example, the target application may be able to run the function indicated by the target operation scenario normally within the operation period indicated by the target operation scenario and remain in the normal operation state until the target application ends. For another example, when the time reaches the start time indicated by the target operation scenario, the target application may be able to run under the target operation scenario normally and maintain the normal operation state before the target application ends operation.

For example, in one embodiment, the operation period indicated by the target operation scenario may be 9:00-10:00. When the target application meets the target condition, the target application may directly start and run the function indicated by the target scenario normally at 9:00, and may maintain the normal operation state before the target application ends operation. For another example, the start time indicated by the target operation scenario may be 9:00. When the target application meets the target condition, the target application may directly start and run the function indicated by the target operation scenario normally at 9:00, and may maintain a normal operation state before the target application ends operation.

In one embodiment of the present disclosure, when the target application does not meet the target condition, it may mean that the target application cannot run normally under the target operation scenario. For example, the target application may not be able to run the function indicated by the target operation scenario normally during the operation period indicated by the target operation scenario. For example, the target application may not be able to start during the operation period indicated by the target operation scenario; or, after the target application is started during the operation period indicated by the target operation scenario, it may not be able to run the function indicated by the target operation scenario normally.

In one embodiment of the present disclosure, when the target application does not meet the target condition, the target application may be updated such that the target application meets the target condition. The time node for updating the target application may be a time before the start time indicated by the target operation scenario, or a preset specific time.

For example, the target operation scenario may indicate that the start time may be 9:00, and the target application not meeting the target condition may mean that it is judged that the target application is not able to start or normally run the function indicated by the target operation scenario at 9:00. Therefore, it may be necessary to update the target application such that the updated target application is able to start or normally run the function indicated by the target scenario at 9:00. The update operation of the target application may need to be completed before the start time indicated by the target operation scenario. For example, the target application may be updated at 8:40 and the time required for the update may not exceed 20 minutes, such that the target application is able to directly start and normally run the function indicated by the target scenario at 9:00 and maintain the normal operation state until the target application ends. For another example, the update of the target application may be completed before 8:40, such that the target application is able to directly start and normally run the function indicated by the target scenario at 9:00 and maintain the normal operation state until the target application ends. The phenomenon that the target application needs to be updated in the target operation scenario due to untimely update may be prevented, thereby avoiding adverse effects on the correct operation of the target application.

For example, in one embodiment, the idle period of the target application may be determined according to the historical operation period of the target application. When the target application does not meet the target condition, the target application may be updated at any time in the idle period such that the target application meets the target condition and the update time is earlier than the start time.

In the embodiments of the present disclosure, by determining whether the target application meets the target condition according to the target information, the target application may be updated in time such that the target application is able to run normally in the operation period indicated by the target operation scenario or when the start time is reached. Therefore, the target application may be able to run normally when it needs to be used, maintain the normal operation state of the target application, and also improve the user's experience of using the target application.

In some embodiments, in S220, in response to determining that the target application does not meet the target condition, updating the target application such that the target application meets the target condition may include: in response to determining that the target application is not able to start in the target operation scenario, updating the target application such that the target application is able to start in the target operation scenario.

In one embodiment of the present disclosure, the target application may not be able to start for the target application to enter the use interface, or the target application may not be able to open any interface. For example, after the user clicks the icon of the target application in the user interface of the terminal device, the user interface may not be able to display the user interface of the target application.

For example, in one embodiment, when the target application version is too low, the target application may not start. In this case, the target application version may be updated such that the updated target application is able to start in the target operation scenario.

For example, in another embodiment, when the configuration file of the target application is lost or the configuration information is abnormal, the target application may also not start. In this case, the target application may be updated to obtain the configuration file of the target application or correct the configuration information such that the updated target application is able to start in the target operation scenario.

In one embodiment of the present disclosure, the method of updating the target application may be updating the entire target application. For example, the complete configuration file of the target application may be re-acquired to update the target application as a whole based on the complete configuration file. For another example, a supplementary configuration file of a new version of the target application may be acquired to update the target application as a whole based on the supplementary configuration file.

In one embodiment of the present disclosure, after the target application as a whole is updated, the updated target application may start normally and run all functions normally. Therefore, when the start time indicated by the target operation scenario is reached, the updated target application may directly start normally, run the functions indicated by the target scenario, and maintain the normal operation state until the target application ends operation.

In some other embodiments, in S220, in response to determining that the target application does not meet the target condition, updating the target application such that the target application meets the target condition may include: determining multiple target functions of the target application; and in response to determining that there is an abnormal function among the multiple target functions, updating the abnormal function such that the updated abnormal function us able to run normally under the target operation scenario.

In one embodiment of the present disclosure, the target functions may include a function used in the target operation scenario, and the abnormal function may be a function that is not able to run normally under the target operation scenario. For example, the target application may start normally, but the operation function indicated by the target operation scenario in the target application may be abnormal and not be able to run normally. In this case, only the abnormal function may be updated, thereby reducing the resource consumption required for the update.

For example, by traversing the configuration file of the target application, the configuration information corresponding to the target functions to be used in the target operation scenario may be determined. When it is determined that the configuration information corresponding to one target function is abnormal, the configuration information corresponding to the target function may be updated.

For example, it may be determined whether the target application has an abnormal function before the target application starts, or it may be determined whether the target application has an abnormal function after the target application starts. After determining the abnormal function, before the abnormal function is run, the abnormal function may be updated such that the updated abnormal function is able to run normally in the target operation scenario.

In one embodiment of the present disclosure, after the abnormal function of the target application is updated, the updated target application may start normally and run all the target functions normally. Therefore, when the start time indicated by the target operation scenario is reached, the updated target application may directly start normally, run all the target functions indicated by the target scenario, and maintain the normal operation state until the target application ends operation.

In some embodiments, when the target application does not meet the target condition, the target application may be detected to determine an update strategy for the target application. For example, the update strategy may include updating the abnormal function of the target application or updating the entire target application.

For example, when the target application does not meet the target condition, it may be determined whether only updating the abnormal function is able to make the target application meet the target condition. When it is determined that only updating the abnormal function is not able to make the target application meet the target condition, the entire target application may be updated. When it is determined that only updating the abnormal function is able to make the target application meet the target condition, only the abnormal function of the target application may be updated, thereby reducing the update overhead.

In some embodiments, updating the abnormal function may include: updating the abnormal function before the target application is run in the target operation scenario; or updating the abnormal function before the abnormal function is run in the target operation scenario.

In one embodiment of the present disclosure, before the target application is run in the target operation scenario, the abnormal function may be updated in advance, which may ensure that the target application before operation is in the correct state of the target functions to avoid unexpected operation conditions as much as possible and determine that the target application is able to run normally in the target operation scenario.

For example, after detecting the abnormal function, the abnormal function may be updated before the start time indicated by the target operation scenario, to make sure that the target function is in the correct state after the target application starts operation.

In the embodiments of the present disclosure, updating the abnormal function after the target application is run and before the abnormal function is run in the target operation scenario may avoid redundant update operations and reduce the update overhead as much as possible. For example, after the target application is run, because of the change of the target operation scenario, the abnormal function in the target function indicated by the original target operation scenario may not need to be used, and the abnormal function may not be updated correspondingly.

For example, according to the current function which is currently running during the operation of the target application, the associated function associated with the current function may be determined. When it is determined that the associated function is an abnormal function, the abnormal function may be updated. For example, the target application may be a social application, and the target operation scenario may be sending a specified message to a specified user at 9:00 on Monday. When the user enters the chat interface of the social application, it may be detected whether there is an abnormality in all functions provided to the user through the chat interface. In the case of determining that there is an abnormal function in the functions provided through the chat interface, the abnormal function may be updated to avoid the situation where the user cannot operate normally when using the corresponding function. During the entire operation of the social application, the associated function of the current function may be continuously detected. When no abnormal function is detected, the abnormal function in the target application may not be updated.

For example, after the target application is run in the target operation scenario, all functions of the target application may be detected to determine the abnormal function. After determining that the associated function of the abnormal function is run, the abnormal function may be updated. For example, the abnormal function may be a function provided to the user through the chat interface. After detecting that the user opens the chat interface, the abnormal function may be updated. When the user does not open the chat interface during the entire operation process of the target application, the abnormal function may not be updated.

In the embodiments of the present disclosure, when the target application does not meet the target condition, according to the update requirements of the target application in the target operation scenario, it may be selected whether to update only the abnormal function or to update the target application as a whole, thereby reducing the update overhead. Further, it may also be possible to select whether to update the abnormal function according to the real-time operation requirements of the abnormal function, thereby reducing unnecessary update operations.

In another embodiment shown in FIG. 3 which is a flow chart of obtaining the target information, obtaining the target information in 210 may include S311 to S312:

S311, obtaining a target event, where the target event is related to the target application; and

S312, analyzing the target event to obtain the target information, where the target information includes the target application and the target operation scenario.

In one embodiment, the target event may be determined by traversing multiple applications. For example, multiple applications may be installed in one terminal device, and the target event related to the target application recorded in the multiple applications may be determined by traversing the multiple applications.

For example, the multiple applications may include a memo application, a recording application, and a calendar application. The memo application, the recording application, and the calendar application may record information about the use of other applications. The target application and the target operation scenario may be determined by analyzing the information recorded by the memo application, the recording application, and the calendar application.

For example, the memo application may record multiple event information. By analyzing the multiple event information, it may be determined whether the content of the multiple event information is related to the target application. When a certain event information is related to the target application, the event information may be considered as the target event. For example, the target event may be a memo application recording “Use the mailbox to send an email to XX at 9:00 on Monday”.

In some embodiments, analyzing the target event to obtain the target information may include: extracting multiple keywords included in the target event; parsing the multiple keywords to obtain the target application and the future time parameters and operation scenario parameters of the target application; and determining the target information based on the future time parameters and the operation scenario parameters.

In one embodiment, the target event may be information in the form of text, voice, video, image, etc. The keywords may be obtained through text recognition, image recognition, voice recognition, etc. The future time parameters may indicate the time when the target application needs to be used, and the operation scenario parameters may indicate the function of the target application that needs to be used.

For example, the target event may be obtained by traversing the calendar application. The target event may be “March 20, 15:00-Application A-Theme: Face-to-face communication”, and the keywords extracted from the target event may include “March 20”, “15:00”, “Application A”, and “Face-to-face communication”. Based on the keywords, the future time parameters may be determined to be 15:00 on March 20 and the operation scenario parameters may be determined to be the camera function of application A.

Through the future time parameters and the operation scenario parameters, it may be determined that the target information is the need to use the camera function of application A at 15:00 on March 20, where the target application is application A and the target operation scenario is face-to-face communication through the camera function at 15:00 on March 20.

In one embodiment of the present disclosure, the target application may meet the target condition, which means that, at 15:00 on March 20, application A is able to start and run normally and the camera is able to be called. When application A cannot be started, application A may be updated as a whole. When application A cannot call the camera, the camera calling function of application A may be updated.

In some embodiments, analyzing the target event to obtain the target information may include: extracting the historical usage information of the target application from the target event; determining the historical time parameters and operation scene parameters for the target application according to the historical usage information; and determining the target information based on the historical time parameters and operation scene parameters.

In one embodiment of the present disclosure, the target event may be information indicating the historical usage of the multiple applications in the terminal device. For example, the target event may be a usage log of the terminal device. The usage log may record the functions used by the multiple applications at different times, and the historical usage information of each application may be obtained from the usage log. For example, the target event may also be traffic monitoring information, etc., and the traffic monitoring information may record the traffic used by each application at different times. When a certain application generates usage traffic at a certain time, it may be considered that the application is used at that time. For example, the target event may also be the historical power consumption of the multiple applications. The historical power consumption may record the power consumption of the multiple applications at different times. When a certain application generates power consumption at a certain moment, it may be considered that the application is used at that moment.

In one embodiment, the historical usage information of the multiple applications recorded by the target event may be analyzed to determine the user's usage habits of the multiple applications, thereby determining the possible target operation scenario.

For example, according to the target event, it may be determined that application A will be used at 15:00 every Wednesday in the past, thereby determining the historical time parameters to be 15:00 on Wednesday, and the operation scenario parameters to be using application A.

Based on the historical time parameters and the operation scenario parameters, it may be determined that the target information includes that application A needs to be used at 15:00 next Wednesday, the target application is application A, and the target operation scenario is to use application A at 15:00 next Wednesday.

In one embodiment, the target application meeting the target condition may indicate that application A is able to start and run normally at 15:00 next Wednesday. When application A is not able to start, application A may be updated as a whole.

In one embodiment, by obtaining the target event related to the target application, the target operation scenario of the target application may be determined, thereby updating the target application according to the target operation scenario to make sure that the target application is able to run normally under the target operation scenario. In addition, a clear target operation scenario may be determined according to the target event, and a possible target operation scenario may also be determined to improve the accuracy of updating the target application.

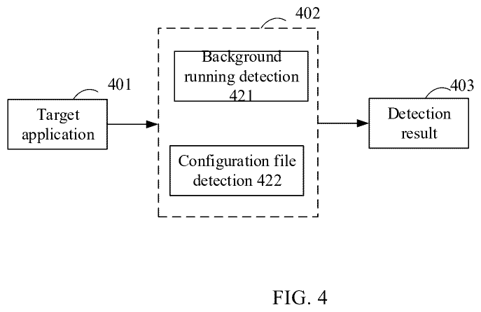

In one embodiment, as shown in FIG. 4 which is a schematic diagram of detecting the target application, update detection may be performed on the target application 401 by a detection manner 402, and whether the target application 401 meets the target condition may be determined based on a detection result 403.

In one embodiment of the present disclosure, the detection manner 402 may include performing a background operation detection 421 on the target application 401 or performing a configuration file detection 422 on the target application 401. For example, the method of determining that the target application does not meet the target condition may include at least one of: in response to determining that the target application does not meet the target condition by running the target application in the background, updating the target application; or, in response to determining that the target application does not meet the target condition by analyzing the configuration file of the target application, updating the target application.

For example, performing the background operation detection 421 on the target application 401 may include: starting the target application 401 in the background and detecting the target function indicated by the target operation scenario in the background operation target application 401. When the target application 401 is not able to start when the background operation detection 421 is performed on the target application 401, it may be considered that the detection result 403 is that the target application 401 does not meet the target condition, such that the target application 401 is updated as a whole. When the target application 401 is able to start during the background operation detection 421 and it is detected that the target function of the target application 401 is not able to run, it may be considered that the detection result 403 is that the target application 401 does not meet the target condition, and the abnormal function of the target application 401 may be updated.

For example, when it is detected that the target application 401 is not able to start because of the configuration file of the target application 401 being too low in version, lost, or having abnormal configuration information, the detection result 403 may be considered that the target application 401 does not meet the target condition, and the target application 401 may be updated as a whole. For another example, the complete configuration file of the target application 401 may be re-acquired to update the target application as a whole based on the complete configuration file. For another example, a supplementary configuration file of a new version of the target application may be obtained to update the target application as a whole based on the supplementary configuration file.

When it is detected that part of the configuration file of the target application 401 is abnormal, resulting in the target application 401 being able to start but the target function is not able to run normally, the detection result 403 may be considered that the target application 401 does not meet the target condition, and the abnormal function of the target application 401 may be updated.

In one embodiment of the present disclosure, after the target application 401 is updated based on the configuration file detection 422, the target application 401 may be re-detected by running the target application 401 in background to determine whether the updated target application 401 meets the target condition. Accordingly, after the target application 401 is updated based on the background operation detection 421, the target application 401 may be further subjected to the configuration file detection 422 to determine whether the updated target application 401 meets the target condition.

In the present disclosure, the operation of performing the update detection on the target application 401 by the detection means 402 may need to be completed before the start time indicated by the target operation scenario. When the detection result 403 is that the target application 401 does not meet the target condition, the update operation of the target application 401 may also need to be completed before the start time indicated by the target operation scenario. Therefore, it may be ensured that the updated target application 401 is able to meet the target condition when the start time indicated by the target operation scenario is reached. The updated target application 401 may run normally in the target operation scenario and remain in normal operation until the target application ends.

In one embodiment, the target application 401 may be pre-detected by multiple detection manners to determine whether the target application 401 meets the target condition, to update or not update the target application 401.

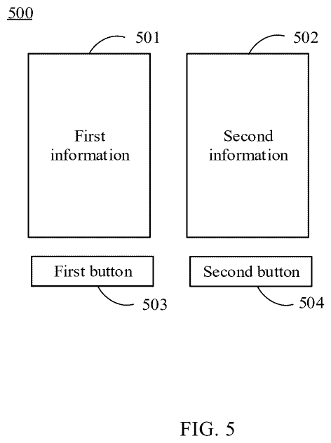

FIG. 5 is a schematic diagram of a display screen according to one embodiment of the present disclosure.

As shown in FIG. 5, the display screen 500 may display first information 501, second information 502, a first button 503, and a second button 504. For example, the first information 501 may indicate the functional information of the target application before the update, and the second information 502 may indicate the functional information of the target application after the update. The first button 503 may indicate updating the target application, and the second button 504 may indicate not updating the target application. For example, the first button 503 may be “update”, and the second button 504 may be “not update”; or the first button 503 may be “yes”, and the second button 504 may be “no”.

In one embodiment of the present disclosure, before updating the target application, the user may independently choose whether to update the target application based on the first information 501 and the second information 502 of the target application displayed through the display screen 500. For example, when the user chooses not to update the target application, the feedback operation for the first information 501 may be performed. When the user chooses to update the target application, the feedback operation for the second information 502 may be performed.

For example, the user clicking the first button 503 may be considered as a feedback operation for the second information 5021, and the user may choose to update the target application. In response to the user's feedback operation on the second information 502, a processing instruction may be generated, and the processing instruction may indicate to update the target application. The user clicking the second button 504 may be regarded as a feedback operation on the first information 501, and the user may choose not to update the target application. In response to the user's feedback operation on the first information 501, a processing instruction may be generated, and the processing instruction may indicate not to update the target application.

For another example, the user may also directly click on the first information 501 or the second information 502, and in response to the user's feedback operation on the first information 501 or the second information 502, a corresponding processing instruction may be generated.

In one embodiment of the present disclosure, the first information 501 and the second information 502 may respectively include version information or function information of the target application before and after the update. The user may choose whether to update the target application according to actual needs.

For example, the first information 501 and the second information 502 may respectively indicate the storage space occupied by the target application before and after the update. The storage space may be less before the update and larger after the update. When the terminal device cannot provide sufficient storage space, the user may perform an operation on the first information 501 such that the target application will not be forced to update.

For another example, the first information 501 and the second information 502 may respectively indicate the operating system support required for the target application before and after the update. The required operating system version before the update may be low, and the required operating system version after the update may be high. When the operating system of the terminal device does not support the updated target application, the user may perform operations on the first information 501 such that the target application will not be forced to update. In the case where the target application is not updated, the operating environment provided by the terminal device may be adapted to the un-updated target application, and the required operating environment may be provided for the un-updated target application such that the un-updated target application is also able to run normally in the target operation scenario.

The contents of the first information 501 and the second information 502 in the previous embodiments of the present disclosure are only schematically described. In actual application scenarios, the user may make corresponding choices based on the functions of updating or not updating the target application provided in the present disclosure.

In one embodiment of the present disclosure, the user's feedback operation on whether the target application is updated may also be completed before the start time indicated by the target operation scenario. Based on the user's feedback operation, the target application may be pre-adapted to the operation environment provided by the terminal device, such that when the start time indicated by the target operation scenario is reached, the target application before the update and the target application after the update may all be able to run normally in the target operation scenario and maintain the normal operation state until the target application ends operation.

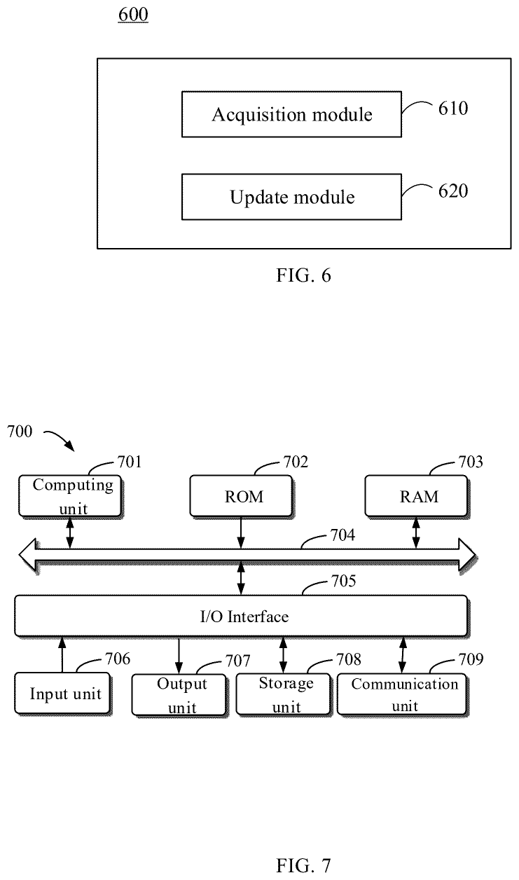

The present disclosure also provides an update device. In one embodiment, as shown in FIG. 6 which is a structural block diagram of the update device, the update device 600 may include an acquisition module 610 and an update module 620.

The acquisition module 610 may be configured to obtain target information, and the target information may be configured to determine a target application and a target operation scenario. In one embodiment, the acquisition module 610 may be configured to perform S210 described above, which will not be repeated here.

The update module 620 may be configured to update the target application in response to determining that the target application does not meet the target condition, such that the target application meets the target condition. In one embodiment, the update module 620 may configured to perform S220 described above, which will not be repeated here.

In one embodiment of the present disclosure, when the update module 620 is configured to update the target application such that the target application meets the target condition in response to determining that the target application does not meet the target condition, the update module 620 may be configured to perform: in response to determining that the target application is not able to start in the target operation scenario, updating the target application such that the target application is able to start in the target operation scenario.

In one embodiment of the present disclosure, when the update module 620 is configured to update the target application such that the target application meets the target condition in response to determining that the target application does not meet the target condition, the update module 620 may be configured to perform: determining multiple target functions of the target application, where one target function is a function used in the target operation scenario; and, in response to determining that there is an abnormal function in the multiple target functions, updating the abnormal function such that the updated abnormal function is able to run normally in the target operation scenario, where the abnormal function is a function that is not able to run normally in the target operation scenario.

In one embodiment of the present disclosure, when the update module 620 is configured to update the abnormal function, the update module 620 may be configured to perform: updating the abnormal function before the target application is run in the target operation scenario; or updating the abnormal function before the abnormal function is run in the target operation scenario.

In one embodiment, when the acquisition module 610 is configured to acquire the target information, the acquisition module 610 may be configured to perform: acquiring a target event, where the target event is related to the target application; and analyzing the target event to acquire the target information, where the target information includes the target application and the target operation scenario.

In one embodiment, when the acquisition module 610 is configured to acquire the target information from the analysis of the target event, the acquisition module 610 may be configured to: extract multiple keywords included in the target event; parse the multiple keywords to acquire the target application and the future time parameters and operation scenario parameters of the target application; and determine the target information based on the future time parameters and the operation scenario parameters.

In one embodiment, when the acquisition module 610 is configured to acquire the target information from the analysis of the target event, the acquisition module 610 may be configured to: extract historical usage information of the target application from the target event; determine historical time parameters and operation scenario parameters for the target application based on the historical usage information; and determine the target information based on the historical time parameters and the operation scenario parameters.

In one embodiment of the present disclosure, when the update module 620 is configured to update the target application in response to determining that the target application does not meet the target condition, the update module 620 may be configured to: update the target application in response to determining that the target application does not meet the target condition by running the target application in the background; or updating the target application in response to determining that the target application does not meet the target condition by analyzing the configuration file of the target application.

In one embodiment of the present disclosure, the update device 600 may also include a display module and a generation module. The display module may be configured to display the first information and the second information of the target application before updating the target application, where the first information indicates the functional information of the target application before the update and the second information indicates the functional information of the target after the update. The generation module may be configured to generate the processing instruction in response to the user's feedback operation on the first information and the second information, and the processing instruction may indicate whether to update the target application or not to update the target application.

It should be noted that in the technical solution of the present disclosure, the collection, storage, use, processing, transmission, provision, disclosure and application of the user's personal information involved are all in compliance with the provisions of relevant laws and regulations, necessary confidentiality measures are taken, and do not violate public order and good customs. In the technical solution of the present disclosure, the user's authorization or consent is obtained before obtaining or collecting the user's personal information.

The present disclosure also provides an electronic device, a computer-readable storage medium, and a computer program product.

As shown in FIG. 7, which is a schematic structural diagram of an exemplary electronic device 700, the electronic device is intended to represent various forms of digital computers, such as laptop computers, desktop computers, workstations, personal digital assistants, servers, blade servers, mainframe computers, or other suitable computers. The electronic device may also represent various forms of mobile devices, such as personal digital processing, cellular phones, smartphones, wearable devices, and or other similar computing devices. The components shown herein, their connections and relationships, and their functions are merely examples and are not intended to limit the implementation of the present disclosure described and/or required herein.

As shown in FIG. 7, the device 700 includes: a computing unit 701, configured to perform various appropriate actions and processes according to a computer program stored in a read-only memory (ROM) 702 or a computer program loaded from a storage unit 708 into a random access memory (RAM) 703. In RAM 703, various programs and data required for the operation of the device 700 may also be stored. The computing unit 701, ROM 702, and RAM 703 may be connected to each other via a bus 704. An input/output (I/O) interface 705 may also be connected to the bus 704.

Multiple components in the device 700 may be connected to the I/O interface 705, including: an input unit 706, such as a keyboard, a mouse, etc.; an output unit 707, such as various types of displays, speakers, etc.; a storage unit 708, such as a disk, an optical disk, etc.; and a communication unit 709, such as a network card, a modem, a wireless communication transceiver, etc. The communication unit 709 may allow the device 700 to exchange information/data with other devices through a computer network such as the Internet and/or various telecommunication networks.

The computing unit 701 may be various general and/or special processing components with processing and computing capabilities. Some examples of the computing unit 701 include, but are not limited to, a central processing unit (CPU), a graphics processing unit (GPU), various special artificial intelligence (AI) computing chips, various computing units running machine learning model algorithms, a digital signal processor (DSP), or any appropriate processor, controller, microcontroller, etc. The computing unit 701 may perform the various methods and processes described above, such as the image processing method. For example, in some embodiments, the image processing method may be implemented as a computer software program, which is tangibly contained in a machine-readable medium, such as a storage unit 708. In some embodiments, part or all of the computer programs may be loaded and/or installed on the device 700 via the ROM 702 and/or the communication unit 709. When the computer program is loaded into the RAM 703 and executed by the computing unit 701, one or more steps of the image processing method described above may be performed. Alternatively, in other embodiments, the computing unit 701 may be configured to perform the image processing method in any other suitable manner (e.g., by means of firmware).

Various embodiments of the systems and techniques described above herein may be implemented in digital electronic circuit systems, integrated circuit systems, field programmable gate arrays (FPGAs), application specific integrated circuits (ASICs), application specific standard products (ASSPs), integrated systems on chips (SOCs), complex programmable logic devices (CPLDs), computer hardware, firmware, software, and/or combinations thereof. These various embodiments may include: being implemented in one or more computer programs that can be executed and/or interpreted on a programmable system including at least one programmable processor, which may be a dedicated or general-purpose programmable processor that can receive data and instructions from a storage system, at least one input device, and at least one output device, and transmit data and instructions to the storage system, the at least one input device, and the at least one output device.

The program code for implementing the methods disclosed herein may be written in any combination of one or more programming languages. These program codes may be provided to a processor or controller of a general-purpose computer, a dedicated computer, or other programmable data processing device, such that the program code, when executed by the processor or controller, causes the functions/operations specified in the flowchart and/or block diagram to be implemented. The program codes may be executed entirely on the machine, partially on the machine, partially on the machine and partially on a remote machine as a stand-alone software package, or entirely on a remote machine or server.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media would include electrical connections based on one or more wires, a portable computer disk, a hard disk, a random access memory (RAM), a read-only memory (ROM), an erasable programmable read-only memory (EPROM or flash memory), optical fiber, a portable compact disk read-only memory (CD-ROM), an optical storage device, a magnetic storage device, or any suitable combination thereof.

To provide interaction with a user, the systems and techniques described herein may be implemented on a computer having: a display device (e.g., a CRT (cathode ray tube) or LCD (liquid crystal display) monitor) for displaying information to the user; and a keyboard and pointing device (e.g., a mouse or trackball) through which the user can provide input to the computer. Other types of devices may also be configured to provide interaction with the user; for example, the feedback provided to the user may be any form of sensory feedback (e.g., visual feedback, auditory feedback, or tactile feedback); and the input from the user may be received in any form (including acoustic input, voice input, or tactile input).

The systems and techniques described herein may be implemented in a computing system that includes a backend component (e.g., as a data server), or a computing system that includes a middleware component (e.g., an application server), or a computing system that includes a frontend component (e.g., a user computer with a graphical user interface or a web browser through which the user can interact with an implementation of the systems and techniques described herein), or a computing system that includes any combination of such backend components, middleware components, or frontend components. The components of the system may be interconnected by any form or medium of digital data communication (e.g., a communications network). Examples of communication networks include: local area networks (LANs), wide area networks (WANs), and the Internet.

A computer system may include a client and a server. The client and server may be generally remote from each other and usually interact through a communication network. The client-server relationship may be generated by computer programs running on corresponding computers and having a client-server relationship with each other. The server may be a cloud server, a server of a distributed system, or a server combined with a blockchain.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only configured to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a . . . ” or “includes a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An update method, comprising:
obtaining target information, wherein the target information is configured to determine a target application and a target operation scenario; and
in response to determining that the target application does not meet a target condition, updating the target application such that the target application meets the target condition, wherein the target condition indicates that the target application is able to operate normally in the target operation scenario.

2. The method according to claim 1, wherein:
in response to determining that the target application does not meet the target condition, updating the target application such that the target application meets the target condition includes:
in response to determining that the target application cannot be started in the target operation scenario, updating the target application such that the target application is able to be started in the target operation scenario.

3. The method according to claim 1, wherein:
in response to determining that the target application does not meet the target condition, updating the target application such that the target application meets the target condition includes:
determining a plurality of target functions of the target application, wherein the plurality of target functions is used in the target operation scenario; and
in response to determining that there is an abnormal function among the plurality of target functions, updating the abnormal function such that updated function is able to operate normally in the target operation scenario, wherein the abnormal function is a function that cannot operate normally in the target operation scenario.

4. The method according to claim 3, wherein:
updating the abnormal function includes:
updating the abnormal function before the target application is run in the target operation scenario; or
updating the abnormal function before the abnormal function is run in the target operation scenario.

5. The method according to claim 1, wherein:
obtaining the target information includes:
obtaining a target event, wherein the target event is related to the target application; and
analyzing the target event to obtain the target information, wherein the target information includes the target application and the target operation scenario.

6. The method according to claim 5, wherein:
analyzing the target event to obtain the target information includes:
extracting a plurality of keywords included in the target event;
parsing the plurality of keywords to obtain the target application, and future time parameters and operation scenario parameters of the target application; and
determining the target information based on the future time parameters and the operation scenario parameters.

7. The method according to claim 5, wherein:
analyzing the target event to obtain the target information includes:
extracting historical usage information of the target application from the target event;
determining historical time parameters and operation scenario parameters of the target application based on the historical usage information; and
determining the target information based on the historical time parameters and the operation scenario parameters.

8. The method according to claim 1, wherein:
in response to determining that the target application does not meet the target condition, updating the target application includes:
in response to determining that the target application does not meet the target condition by running the target application in the background, updating the target application; or
in response to determining that the target application does not meet the target condition by analyzing a configuration file of the target application, updating the target application.

9. The method according to claim 1, before updating the target application, further including:
displaying first information and second information of the target application, wherein the first information indicates functional information of the target application before being updated and the second information indicates functional information of the target application after being updated; and
generating a processing instruction in response to a user's feedback operation on the first information and the second information, wherein the processing instruction indicates whether to update the target application or not to update the target application.

10. An electronic device, comprising:
one or more processors; and
a memory coupled with the one or more processors and containing at least one instruction that, when being executed, causes the one or more processors to:
obtain target information, wherein the target information is configured to determine a target application and a target operation scenario; and
in response to determining that the target application does not meet a target condition, update the target application such that the target application meets the target condition, wherein the target condition indicates that the target application is able to operate normally in the target operation scenario.

11. The device according to claim 10, wherein the one or more processors are further configured to:
in response to determining that the target application is unable to be started in the target operation scenario, update the target application such that the target application is able to be started in the target operation scenario.

12. The device according to claim 10, wherein the one or more processors are further configured to:
determine a plurality of target functions of the target application, wherein the plurality of target functions is functions used in the target operation scenario; and
in response to determining that there is an abnormal function among the plurality of target functions, update the abnormal function such that the updated abnormal function is able to operate normally in the target operation scenario, wherein the abnormal function is a function that cannot operate normally in the target operation scenario.

13. The device according to claim 12, wherein the one or more processors are further configured to:
update the abnormal function before the target application is run in the target operation scenario; or
update the abnormal function before the abnormal function is run in the target operation scenario.

14. The device according to claim 10, wherein the one or more processors are further configured to:
obtain a target event, wherein the target event is related to the target application; and
analyze the target event to obtain the target information, wherein the target information includes the target application and the target operation scenario.

15. The device according to claim 14, wherein the one or more processors are further configured to:
extract a plurality of keywords included in the target event;
parse the plurality of keywords to obtain the target application, and future time parameters and operation scenario parameters of the target application; and
determine the target information based on the future time parameters and the operation scenario parameters.

16. The device according to claim 14, wherein the one or more processors are further configured to:
extract historical usage information of the target application from the target event;
determine historical time parameters and operation scenario parameters of the target application based on the historical usage information; and
determine the target information based on the historical time parameters and the operation scenario parameters.

17. The device according to claim 10, wherein the one or more processors are further configured to:
in response to determining that the target application does not meet the target condition by running the target application in the background, update the target application; or
in response to determining that the target application does not meet the target condition by analyzing a configuration file of the target application, update the target application.

18. The device according to claim 10, wherein the one or more processors are further configured to:
display first information and second information of the target application, wherein the first information indicates functional information of the target application before being updated and the second information indicates functional information of the target application after being updated; and
generate a processing instruction in response to a user's feedback operation on the first information and the second information, wherein the processing instruction indicates whether to update the target application or not to update the target application.

19. A non-transitory computer readable storage medium containing at least one instruction that, when being executed, causes at least one processor to:
obtain target information, wherein the target information is configured to determine a target application and a target operation scenario; and
in response to determining that the target application does not meet a target condition, update the target application such that the target application meets the target condition, wherein the target condition indicates that the target application is able to operate normally in the target operation scenario.

20. The storage medium according to claim 19, wherein the at least one processor is further configured to:
in response to determining that the target application is unable to be started in the target operation scenario, update the target application such that the target application is able to be started in the target operation scenario.
